(19) United States
(12) Patent Application Publication
(10) Pub. No.: US 2026/0158735 A1
(43) Pub. Date: Jun. 11, 2026

(54) Linkage Roller Press Film Sticking Fixture

(71) Applicant: Guofeng Huang, Shenzhen City (CN)

(72) Inventor: Guofeng Huang, Shenzhen City (CN)

(21) Appl. No.: 18/982,674

(22) Filed: Dec. 16, 2024

(30) Foreign Application Priority Data
Dec. 10, 2024 (CN) 202411803825.7
Dec. 15, 2024 (CN) 202323428212.3

(51) Int. Cl. B29C 63/02; B29C 63/00

(52) U.S. Cl. CPC B29C 63/025; B29C 63/0004; B29C 2063/0008

(57) ABSTRACT

A linkage roller press film sticking fixture is provided, which includes a fixture body and an upper cover that is rotatably connected to an end of the fixture body. An upper of the fixture body is slidably connected with a roller press member configured to roll a mobile phone sticker. The upper cover and the roller press piece are connected to a linkage member. Through the linkage member, the upper cover can drive the roller press member to move back and forth on the fixture body during the opening and closing process, thereby reciprocating rolling the mobile phone sticker. By rolling back and forth between the mobile phone sticker and a screen with a roller press shaft, bubbles in the mobile phone sticker can be squeezed out. The roller press member is provided with a sliding guide groove between the frame body and a roller shaft installation port.

### CROSS-REFERENCE TO RELATED APPLICATIONS

This application claims priority to Chinese Patent Application No. 202411803825.7, filed on Dec. 10, 2024 and No. 202323428212.3, filed on Dec. 15, 2023, which is hereby incorporated by reference in its entirety.

### TECHNICAL FIELD

The present disclosure relates to the field of film sticking fixture technologies, and in particular, to a linkage roller press film sticking fixture.

### BACKGROUND

When pasting protective film on a screen of a mobile phone, the adhesive effect of the film is improved by a film sticking fixture. There are existing fixture structures for mobile phone sticker, such as in Chinese patent with publication No. CN219295788, which discloses a dust-free film sticking artifact protective film set for curved screen mobile phones. During use, after opening the cover, the film sticking set needs to be repeatedly rolled by holding a film sticking structure (handle, soft roller), that is, opening the cover first and then manually rolling, which cannot be done simultaneously. The efficiency is low and laborious, and the position of the hand is small. When encountering high resistance, it is easy to slip. Furthermore, two sides of a roller are directly connected by protruding rods, which has a large damping effect during operation. Therefore, a linkage roller press film sticking fixture is proposed.

### SUMMARY

In response to the shortcomings of existing technology, the present disclosure provides a linkage roller press film sticking fixture, which solves the problems raised by the background technology mentioned above.

To achieve the above objectives, the present disclosure is implemented through the following technical solution: a linkage roller press film sticking fixture, including a fixture body and an upper cover that is rotatably connected to an end of the fixture body, where an upper of the fixture body is slidably connected with a roller press member configured to roll a mobile phone sticker, and a linkage member is connected between the upper cover and the roller press member, the upper cover drives the roller press member to move back and forth on the fixture body during opening and closing process by the linkage member, thereby rolling back and forth the mobile phone sticker.

In some embodiments of the present disclosure, the fixture body is provided with a mobile phone accommodation cavity, and two sides of the fixture body are provided with sliding grooves; two sides of a top of the fixture body that is located in the mobile phone accommodation cavity are connected to limit protrusions and limit columns, respectively.

In some embodiments of the present disclosure, the upper cover is symmetrically connected with clamping pieces, and the clamping pieces are rotatably connected to a top of the linkage member.

In some embodiments of the present disclosure, the roller press member includes a frame body provided on an upper of the fixture body, and two sides of an interior of the frame body are provided with bearings; a first roller press shaft and a second roller prese shaft are rotatably connected on an inner side of the frame body.

In some embodiments of the present disclosure, a top of the frame body is provided with locking grooves that are rotatably connected to a bottom of the linkage member.

In some embodiments of the present disclosure, a top end and a bottom end of the linkage member are both connected with convex shafts that are symmetrically arranged.

In some embodiments of the present disclosure, a middle of an inner side of the roller press member is provided with a plurality of roller shaft installation ports, and a middle of the roller press member is provided with the second roller press shaft, the second roller press shaft is provided in the roller shaft installation ports, and the roller shaft installation ports are C-shaped.

In some embodiments of the present disclosure, guide groove installation ports are provided on two upper sides of the fixture body, the guide groove installation ports are adapted to sizes of the bearings, allowing the bearings to slide into the sliding groove through the guide groove installation ports.

In some embodiments of the present disclosure, the frame body of the roller press member is provided on an outer side of the fixture body, one bearing at an inner side of the frame body is slidably connected to one sliding groove at an outer side the fixture body, and the limit protrusions on a side of the fixture body that is close to the upper cover are configured to be slopes.

In some embodiments of the present disclosure, the roller press member is provided with a sliding guide groove between the frame body and the roller shaft installation ports, the sliding guide groove is adapted to outer edge dimensions of two sides of the fixture body.

The present disclosure provides a linkage roller press film sticking fixture. Compared with existing technologies, it has the following beneficial effects.

In this film sticking fixture, the upper cover dives the linkage member to pull the roller press member to move on the fixture body. During a movement, the bearings are slid in the sliding groove. The first roller press shaft and the second roller press shaft can be used in combination, or one of them can be used separately. Installation and use can be carried out according to the user's needs. By rolling the roller press shaft back and forth between the mobile phone sticker and a screen, bubbles in the mobile phone sticker can be squeezed out. The roller press member is provided with a sliding guide groove between the frame body and the roller shaft installation ports. The sliding guide groove is adapted to outer edge sizes on two sides of the fixture body, which can have two functions: the upper has a guide effect, and the side has a sliding groove guide effect, which is smooth and very silky.

### BRIEF DESCRIPTION OF DRAWINGS

FIG. 1 is a schematic structural diagram of the present disclosure.

FIG. 2 is a schematic structural diagram of a fixture body in the present disclosure.

FIG. 3 is a schematic structural diagram of a roller press member in a first perspective of the present disclosure.

FIG. 4 is a schematic structural diagram of the roller press member in a second perspective of the present disclosure.

FIG. 5 is a schematic structural diagram of a linkage member in the present disclosure.

FIG. 6 is a front sectional view of the present disclosure.

FIG. 7 is a first schematic structural diagram of the roller press member in the present disclosure.

FIG. 8 is a second schematic structural diagram of the roller press member in the present disclosure.

FIG. 9 is a sectional view of a right side of the present disclosure.

FIG. 10 is a schematic diagram of a sliding guide groove of the present disclosure.

Numeral reference: 1—fixture body; 11—mobile phone accommodation cavity; 12—sliding groove; 122—guide groove installation port, 13—limit protrusion; 14—limit column; 2—upper cover; 21—clamping piece; 3—roller press member; 31—frame body; 32—bearing; 33—first roller press shaft, 331—roller shaft installation port; 332—sliding guide groove, 34—second roller press shaft; 35—locking groove; 4—linkage member; 41—convex shaft.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

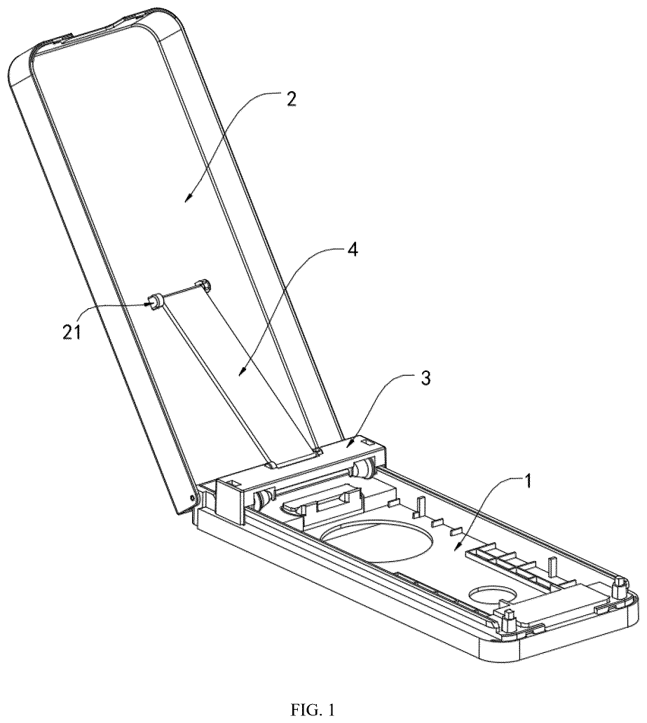

Please refer to FIG. 1, the present disclosure provides a linkage roller press film sticking fixture, which includes a fixture body 1 and an upper cover 2 that is rotatably connected to an end of the fixture body 1. An upper of the fixture body 1 is slidably connected with a roller press member 3 configured to roller a mobile phone sticker. A linkage member 4 is jointly connected between the upper cover 2 and the roller press member 3. Clamping pieces 21 are symmetrically connected to an interior of the upper cover 2, and the clamping pieces 21 are rotatably connected to a top of the linkage member 4. Through the linkage member 4, the upper cover 2 can drive the roller press member 3 to move back and forth on the fixture body 1 during opening and closing process, thereby reciprocating rolling the mobile phone sticker, compared to the existing technology film sticking fixture, the film sticking fixture in this embodiment, there is no need to manually roll the mobile phone sticker multiple times during a sticking process, it is only to simply open and close the top cover of the film sticking fixture times to complete the rolling process of the mobile phone sticker.

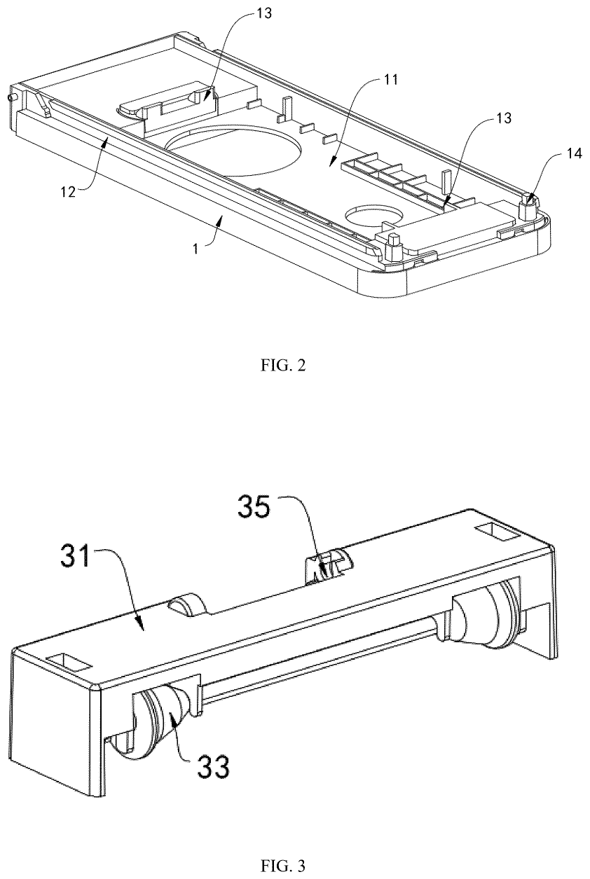

Please refer to FIG. 2, an interior of the fixture body 1 is provided with a mobile phone accommodation cavity 11, and two sides of the fixture body 1 are provided with sliding grooves 12. Two sides of a top of the fixture body 1 that is located in the mobile phone accommodation cavity 11 are symmetrically connected to limit protrusions 13 and limit columns 14, respectively. The limit protrusions 13 and the limit columns 14 are used to position the mobile phone sticker and prevent deviation.

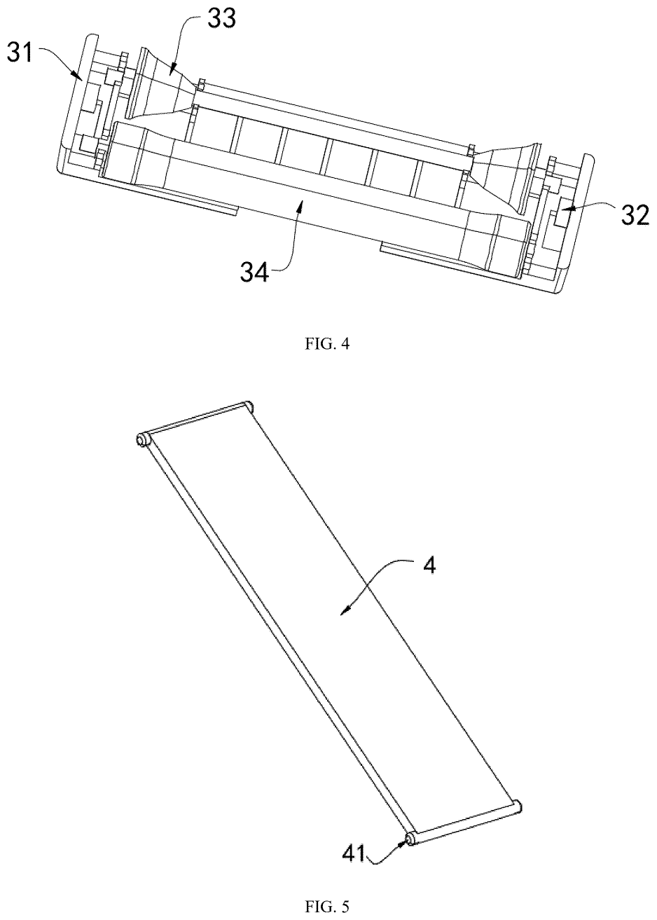

Please refer to FIGS. 3 and 4, the roller press member 3 includes a frame body 31 that is slidably provided an upper of the fixture body 1. Bearings 32 are fixedly connected on two sides of an interior of the frame body 31 (bearings 32 are slid in the sliding groove 12). A first roller press shaft 33 and a second roller press shaft 34 are rotatably connected in the frame body 31. Two sides of the first roller press shaft 33 are rolled on two sides of the mobile phone sticker, and the second roller press shaft 34 mainly rolls on a middle of the mobile phone sticker. A top of the frame body 31 is symmetrically provided with locking grooves 35 that are rotatably connected to a bottom of the linkage member 4.

Please refer to FIG. 5, a top end and a bottom end of the linkage member 4 are connected to convex shafts 41 that are symmetrically arranged, which are respectively clamped in the clamping piece 21 and the locking groove 35 and they are rotatably connected.

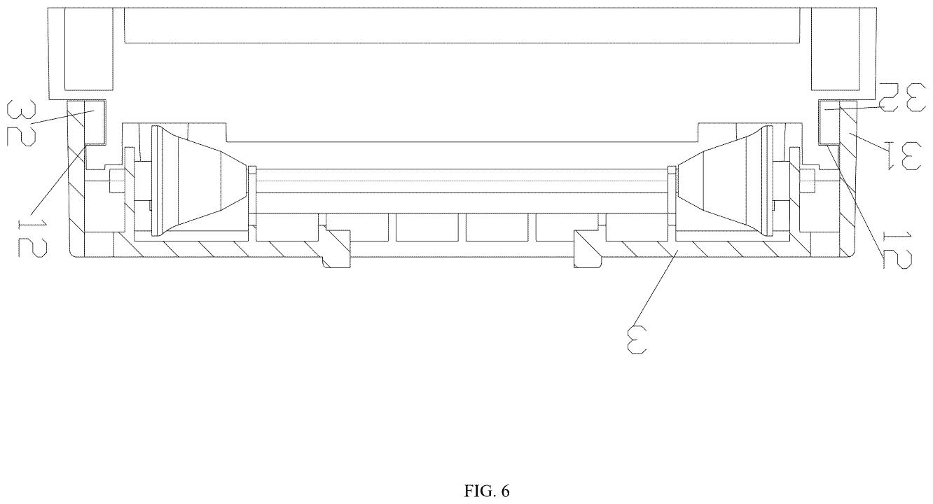

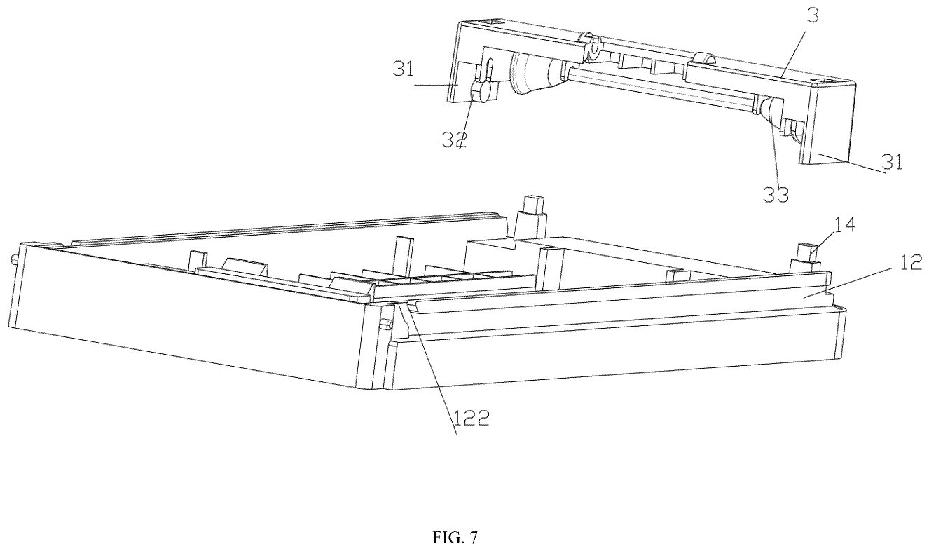

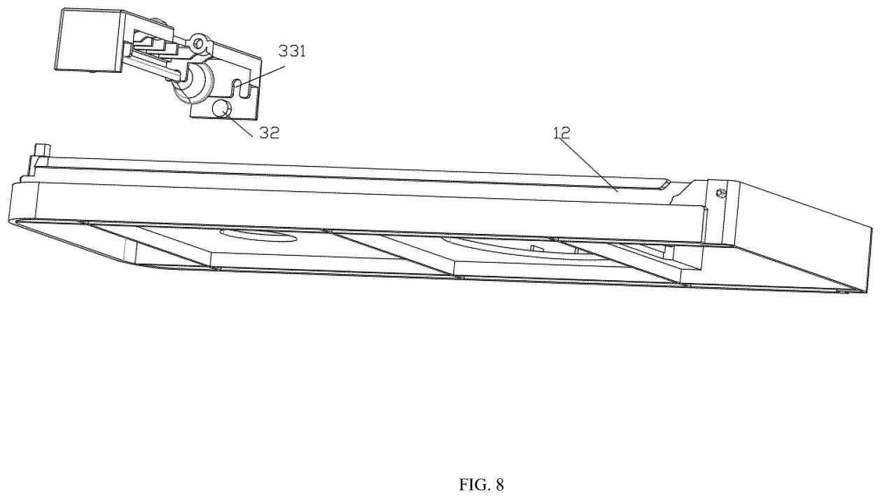

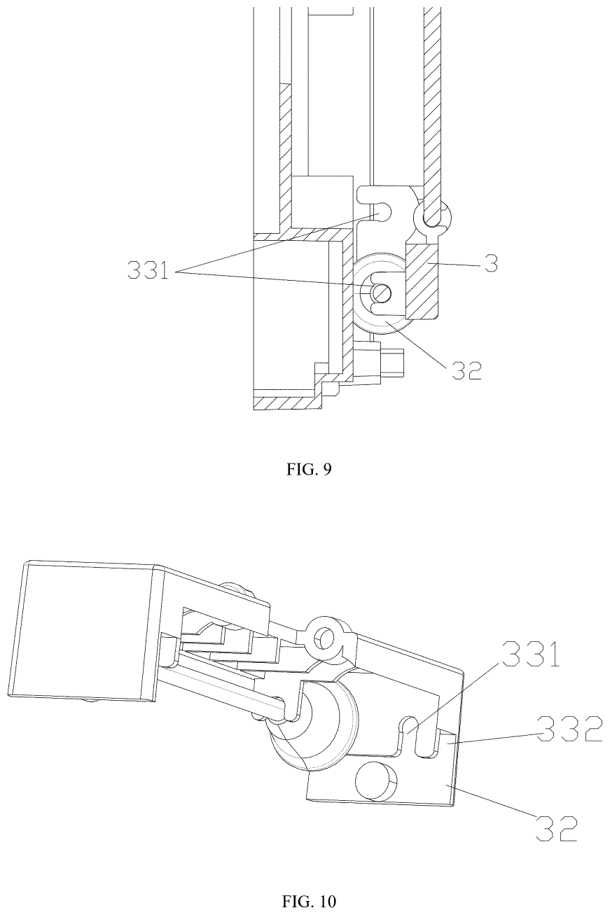

Please refer to FIGS. 6-10. A plurality of roller shaft installation ports 331 are provided in a middle of an inner side of the roller press member 3. A middle of the roller press member 3 is provided with the second roller press shaft 34, and the second roller press shaft 34 is provided in the roller shaft installation ports 331. The roller shaft installation ports 331 are C-shaped, so that the roller press shaft can be installed in by a tension of the C-shaped port and will not fall out. When disassembling, it can be replaced and disassembled by pulling with force.

Two upper sides of the fixture body 1 are provided with guide groove installation ports 122, the guide groove installation ports 122 are adapted to sizes of the bearings 32. The bearings 32 are slid into the sliding groove 12 through the guide groove installation ports 122. The guide groove installation ports 122 are reduced in size, like a horn mouth style. Thus, the installation can be faster.

The frame body 31 of the roller press member 3 is provided on an outer side of the fixture body 1, and one bearing 32 at an inner side of the frame body 31 is slidably connected to one sliding groove 12 at an outer side of the fixture body 1. The limit protrusion 13 on one side of the fixture body 1 that is close to the upper cover 2 is configured to be slope, which can activate a damping effect. Because the second roller press shaft 34 is made of foam or silicone material, it is deformed by squeezing the second roller press shaft 34 and passes over the limit protrusions 13 before being connected to a mobile phone in an upper of the mobile phone accommodation cavity 11. This plays a support for the upper cover 2, as shown in FIG. 1.

The roller press member 3 is provided with a sliding guide groove 332 between the frame body 31 and the roller shaft installation ports 331. The sliding guide groove 332 is adapted to outer edge dimensions on two sides of the fixture body 1, which can have two purposes: the upper has a guide effect, and the side has the sliding groove 12 for sliding guide, which has a smooth effect.

Working principle: when in use, the mobile phone is placed in the mobile phone accommodation cavity 11, and then the mobile phone sticker is fixed on the limit protrusions 13 and the limit columns 14. The existing mobile phone sticker have positioning holes that are compatible with the size of the limit columns 14. After being fastened, the mobile phone sticker will be aligned with a position where the mobile phone is placed. Then, the upper cover 2 pulls the linkage member 4 to pull the roller press member 3 to move on the fixture body 1. During the movement, the bearings 32 are slid in the sliding groove 12, and the first and second roller press shafts 33 and 34 respectively roll the mobile phone sticker. It should be noted that the first and second roller press shafts 33 and 34 can be used in combination, or one of them can be used separately. Installation and use can be carried out according to user needs, the roller press shaft roll back and forth between the mobile phone sticker and a screen, the user can squeeze out bubbles in the mobile phone sticker and the mobile phone sticker can be fit well, thereby replacing a use of a scraper.

What is claimed is:

1. A linkage roller press film sticking fixture, comprising a fixture body and an upper cover that is rotatably connected to an end of the fixture body,
wherein an upper of the fixture body is slidably connected with a roller press member configured to roll mobile phone sticker, and a linkage member is connected between the upper cover and the roller press member,
the upper cover drives the roller press member to move back and forth on the fixture body during opening and closing process by the linkage member, thereby rolling back and forth the mobile phone sticker.

2. The linkage roller press film sticking fixture according to claim 1, wherein the fixture body is provided with a mobile phone accommodation cavity, and two sides of the fixture body are provided with sliding grooves;
two sides of a top of the fixture body that is located in the mobile phone accommodation cavity are connected to limit protrusions and limit columns, respectively.

3. The linkage roller press film sticking fixture according to claim 1, wherein the upper cover is symmetrically connected with clamping pieces, and the clamping pieces are rotatably connected to a top of the linkage member.

4. The linkage roller press film sticking fixture according to claim 1, wherein the roller press member comprises a frame body provided on an upper of the fixture body, and two sides of an interior of the frame body are provided with bearings;
a first roller press shaft is rotatably connected on an inner side of an upper of the frame body.

5. The linkage roller press film sticking fixture according to claim 4, wherein a top of the frame body is provided with locking grooves that are rotatably connected to a bottom of the linkage member.

6. The linkage roller press film sticking fixture according to claim 1, wherein a top end and a bottom end of the linkage member are both connected with convex shafts that are symmetrically arranged.

7. The linkage roller press film sticking fixture according to claim 1, wherein a middle of an inner side of the roller press member is provided with a plurality of roller shaft installation ports, and a middle of the roller press member is provided with a second roller press shaft, the second roller press shaft is provided in the roller shaft installation ports, and the roller shaft installation ports are C-shaped.

8. The linkage roller press film sticking fixture according to claim 1, wherein guide groove installation ports are provided on two upper sides of the fixture body,
the guide groove installation ports are adapted to sizes of the bearings, allowing the bearings to slide into the sliding groove through the guide groove installation ports.

9. The linkage roller press film sticking fixture according to claim 1, wherein the frame body of the roller press member is provided on an outer side of the fixture body, one bearing at an inner side of the frame body is slidably connected to one sliding groove at an outer side the fixture body, and the limit protrusions on a side of the fixture body that is close to the upper cover are configured to be slopes.

10. The linkage roller press film sticking fixture according to claim 2, wherein the roller press member is provided with a sliding guide groove between the frame body and the roller shaft installation ports,
the sliding guide groove is adapted to outer edge dimensions of two sides of the fixture body.
